(19) United States
(12) Patent Application Publication
(10) Pub. No.: US 2008/0284061 A1
(43) Pub. Date: Nov. 20, 2008

(54) Apparatus and Process for In-molding Labels onto Plastic

(76) Inventors: Pedro Jorge Pinto Oliveira Araujo, (US); Pedro Miguel Gomes de Sa, (US)

Correspondence Address: Law Offices of Mark E. Wiemelt, P.C., Suite 3300, 10 S. LaSalle Street, Chicago, IL, 60603, US

(21) Appl. No.: 11/749,844

(22) Filed: May 17, 2007

(51) Int. Cl. B29C 45/00

(52) U.S. Cl. 264/328.15; 425/404; 428/213

(57) ABSTRACT

An apparatus and process for fusing labels onto plastic parts having multiple contoirs and/or holes during the molding process is presented. According to the invention, a label having art work or wording on its interior surface and made of the same material as the plastic piece to which it is to be applied, is positioned onto a mold. Placement is accomplished through the use of a robotic arm having an insulated plate at its operational end to eliminate electrical charge transfer to the tool. The interior side of the label is insulated. An electrical charge is then applied to the front surface of the label enabling it to be positioned and held in place on an irregularly shaped mold. In the preferred embodiment, polypropylene is used for the label and the plastic layer.

### I. TECHNICAL FIELD OF THE INVENTION

The present invention generally relates to the in molding of labels onto plastic pieces and more particularly to an apparatus and process for in molding labels onto plastic parts of varied shapes, sizes, and contours.

### II. BACKGROUND OF THE INVENTION AND PRIOR ART

Molding plastic pieces, particularly those of irregular shape and configuration can be an intricate and complex undertaking. For example, in the molding of plastic parts for motorcycles there are many irregularly shaped pieces, such as radiator scoops, or pieces of irregular shape and have holes in them, such as for areas requiring ventilation.

It is also necessary that in many instances the plastic used must be of a rugged and durable nature yet flexible. Again, in the case of motorcycle parts it is generally desirable that the parts be made of a plastic that can withstand tremendous forces without breaking and must be resilient enough to withstand undue scratching and chipping.

Due to these requirements, polypropylene plastic is often employed. Polypropylene is a robust plastic used in everything from plastic bottles to carpets to plastic furniture, and is very heavily used in automobiles and motorcycles.

Polypropylene is partially crystalline and partially amorphous in molecular structure, giving it both a melting point (the temperature at which the attractive intermolecular forces are overcome) and a glass transition (temperatures above which the extent of localized molecularization is substantially increased). It is found in the group of plastics that include, among others, polyethylene, poly vinyl chloride, polyamides (nylons), polyesters and some polyurethanes.

Typically, polypropylene parts are molded through injection molding. In injection molding, injection molding machines hold the molds in which the components are shaped. Resin, or raw material for injection molding, is usually in pellet or granule form, and is melted by heat and shearing forces shortly before being injected into the mold. After injection into the mold, the resin is held in place by the mold shape until it is sufficiently hardened that the plastic part can be extracted from the mold.

It is often desired to decorate plastic parts with indicia, usually in the form of labels. Traditionally, labels have been affixed to the exterior surface of a plastic piece after the piece has been molded. Among the many shortcomings of the prior art are that labels become easily scratched; there is not a solid bond between the label and the plastic part resulting in peeling; the label is subject to UV rays and, therefore, to fading; and, the part is not recyclable for the reason that the labels are not compatible with the underlying plastic piece. Additionally, there is added cost to the process of applying the label since it must be handled once for the molding process and a second time to add the label.

In molding of labels addresses many of these issues. However, until the present invention, in molding techniques have generally required that a plastic piece, or an area of a plastic piece, to which a label is to be molded be flat, or nearly flat, or uniformly round, such as a bucket, and be of a regular shape and without holes. Additionally, molds have generally included a cavity in the desired location of the label placement.

The reason for the foregoing is that prior art in molding techniques have relied upon an electrical charge applied to the back of a label to transfer and hold the label in place on a mold. This, in turn, has limited the ability to transfer and hold labels in place on contoured surfaces or those with holes as the labels are prone to slip, thereby resulting in an unacceptable level of rejected pieces.

There is need, therefore, for an apparatus and process in which labels can be permanently bonded to plastic parts of varied contours or with holes in them such that the labels adhere to the plastic part, resist fading, scratching, and peeling, are recyclable, and is economical.

### III. OBJECTS OF THE INVENTION

It is an object of the present invention to provide an in molding apparatus that enables the placement of labels onto plastic parts of varied contours or with holes in them during the molding process.

It is a further object of the present invention to provide an in molding apparatus that provides an electrical charge to the front surface of a label.

It is a further object of the present invention to provide an in molding apparatus that utilizes a foam that provides insulation, thereby keeping an electrical charge from traveling over the back surface of a label, directs flow of the electrical charge, and works as a buffer that offers protection to the tool, thereby reducing the likelihood of tool damage.

It is a further object of the present invention to provide an in molding process that enables the placement of labels onto plastic parts of varied contours or with holes in them during the molding process.

It is yet a farther object of the present invention to provide an in molding process that provides an electrical charge to the front surface of a label.

It is a farther object of the present invention to provide an in molding process that employs a foam that provides insulation, thereby keeping an electrical charge from traveling over the back surface of a label, directs flow of the electrical charge, and works as a buffer that offers protection to the tool, thereby reducing the likelihood of tool damage.

It is yet a further object of the present invention to provide a molding apparatus and process in which labels can be placed and held with commercial accuracy onto plastic pieces of any shape or contour or with holes in them.

It is a further object of the present invention to provide an in molding process in which labels resist fading, scratching, and peeling.

It is yet a further object of the present invention to provide such an apparatus and process that is cost effective.

### IV. SUMMARY OF THE INVENTION

The foregoing objects of the invention are provided for in an inventive process for in molding labels onto plastic parts of varied contours and/or with holes in them during the molding process. According to the invention, a label having art work or wording on its interior surface and made of the same material as the plastic piece to which it is to be applied, is positioned onto a mold. Placement is accomplished through the use of a robotic arm having an insulated plate at its operational end to eliminate electrical charge transfer to the tool. The back surface of the label is insulated. This can be done through any commercially acceptable means. The inventors have found that a semi-conductive foam works well. It is applied to the robotic arm between the tool and the label. Alternatively, a pre-insulated label may be used. An electrical charge is then applied to the front surface of the label enabling it to be positioned and held in place on an irregularly shaped mold.

Then, in the normal in molding fashion, plastic resin of the same composition as the label is placed over the label film and through the application of heat, the label film fuses to the plastic. In the preferred embodiment, polypropylene is used for the label and the plastic layer.

There has been outlined, rather broadly, the more important features of the invention in order that the detailed description thereof that follows may be better understood, and in order that the present contribution to the art may be better appreciated. There are, of course, additional features of the invention that will be described hereinafter and that will form the subject matter of the invention.

For non-limiting example, while the Specification focuses on polypropylene plastic and injection molding, those skilled in art will quickly realize that the process disclosed herein will work with a variety of plastics and with a variety of plastic forming techniques, such as, but not limited to, thermo molding. As such, those skilled in the art will appreciate that the conception, upon which this disclosure is based, may readily be utilized as a basis for designing of other structures, methods, and systems for carrying out the several purposes of the present invention. It is important, therefore, that the claims be regarded as including such equivalent constructions in so far as they do not depart from the spirit and scope of the present invention.

Further, the purpose of the abstract is to enable the US patent and trademark office and the public generally, and especially the scientists, engineers and practitioners in the art who are not familiar with the patent or legal terms or phraseology, to determine quickly from what cursory inspection the nature and essence of the technical disclosure of the application. The abstract is neither intended to define the invention of the application, which is measured by the claims, nor is it intended to be limiting as to the scope of the present invention in any way.

These together with other objects of the present invention, along with the various features of novelty which characterize the present invention, are pointed out with particularity in the claims annexed to and forming a part of this disclosure. For a better understanding of the present invention, its operating advantages and the specific objects attained by its uses, reference should be had to the accompanying drawings and descriptive matter in which there is illustrated a preferred embodiment of the present invention.

### V. BRIEF DESCRIPTION OF THE DRAWINGS

FIG. 1 is a top perspective view of a plastic part made with the inventive method illustrating the preferred embodiment utilizing a label and a plastic layer.

FIG. 2 is a top perspective view of a plastic part without a label.

FIG. 3 is a top perspective view of a label.

FIG. 4 is an example of the prior art illustrating that the sticker is placed on the outside wall of the plastic piece after molding.

FIG. 5 is a flow chart depicting the method flow of the preferred embodiment.

FIG. 6 is a side view of a plastic part illustrating an alternate embodiment wherein a label with a first label film and a second label film is used, and a plastic layer.

FIG. 7 depicts a side view of the end of the inventive tool.

### VI. DETAILED DESCRIPTION OF THE INVENTION

Before explaining the preferred embodiment of the present invention in detail, it is to be understood that the present invention is not limited in its application to the details of construction and to the arrangements of the components set forth in the following description or illustrated in the drawings. The present invention is capable of other embodiments and of being practiced and carried out in various ways. Also, it is to be understood that the phraseology and terminology employed herein are for the purpose of description and should not be regarded as limiting. And while the disclosure focuses on motorcycles parts, this should in no manner be considered limiting. The method will work for any plastic piece which would benefit from the inventive method.

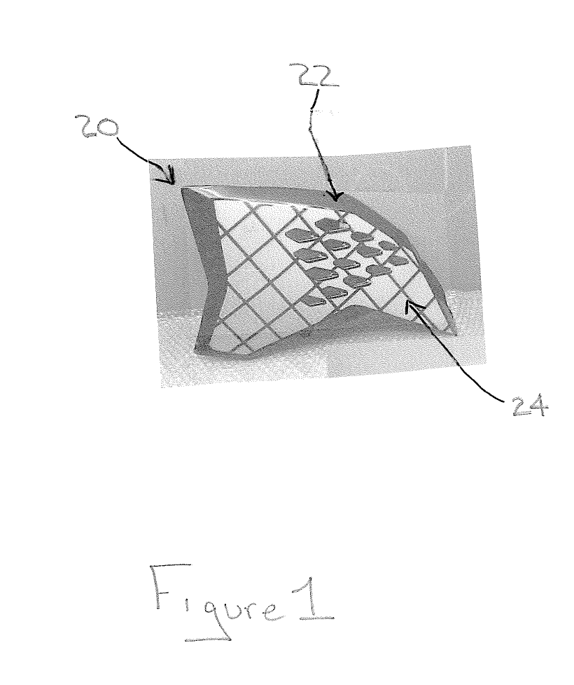

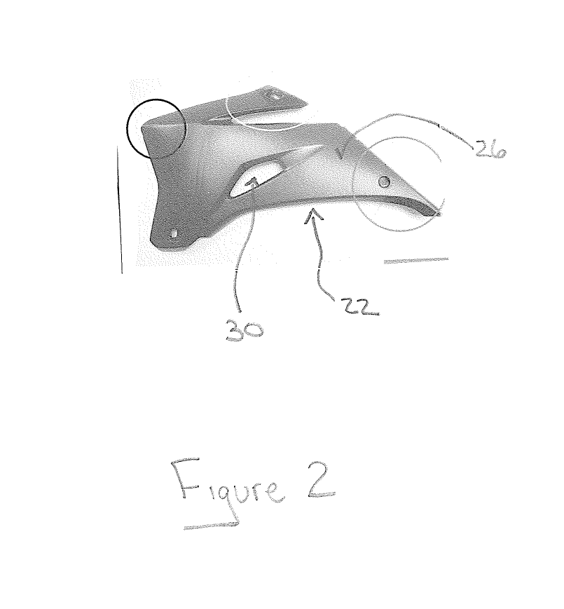

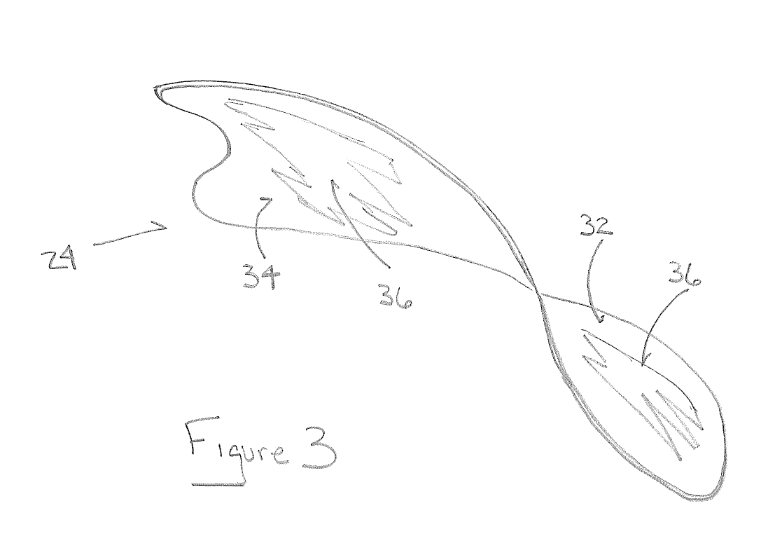

Turning to FIG. 1, plastic part 20 in the form of a side panel for a motorcycle is shown. Plastic part 20 further comprises plastic layer 22 and label 24. As can be seen, plastic part 20 is of irregular shape and has many contoured surface angles. Turning to FIG. 2, plastic layer 22 is shown without label 24. Plastic part 20 has a front side 26, a back side 28 (not shown), and further includes ventilation holes 30. Turning to FIG. 3, a representative label 24 is shown. Label 24 has a back surface 32 and a front surface 34. Back surface 32 further includes indicia markings 36.

Plastic part 20 components plastic layer 22 and label 24 can be made of any plastic material. Non-limiting examples of commonly used materials are polystyrene (a low cost material that lacks the strength and longevity of most other plastics), ABS or acrylonitrile butadiene styrene (a co-polymer or mixture of compounds used for everything from toy parts to electronics housings), nylon (chemically resistant, heat resistant, tough and flexible), polyethylene, polyvinyl chloride or PVC (commonly used for pipes, window frames, or as the insulation on wiring where it is rendered flexible by the inclusion of a high proportion of plasticiser), and polypropylene (tough and flexible, it is used for everything from containers to heavy parts for automobiles and motorcycles).

The Inventors have found that polypropylene works best for the reasons that it is a tough and flexible material that is well suited to complex molding, and, as will be described below, is a material of choice for the preferred molding method-injection molding. As will also be discussed in more detail below, polypropylene offers the best fusion properties for molding label 24 to a plastic layer 22.

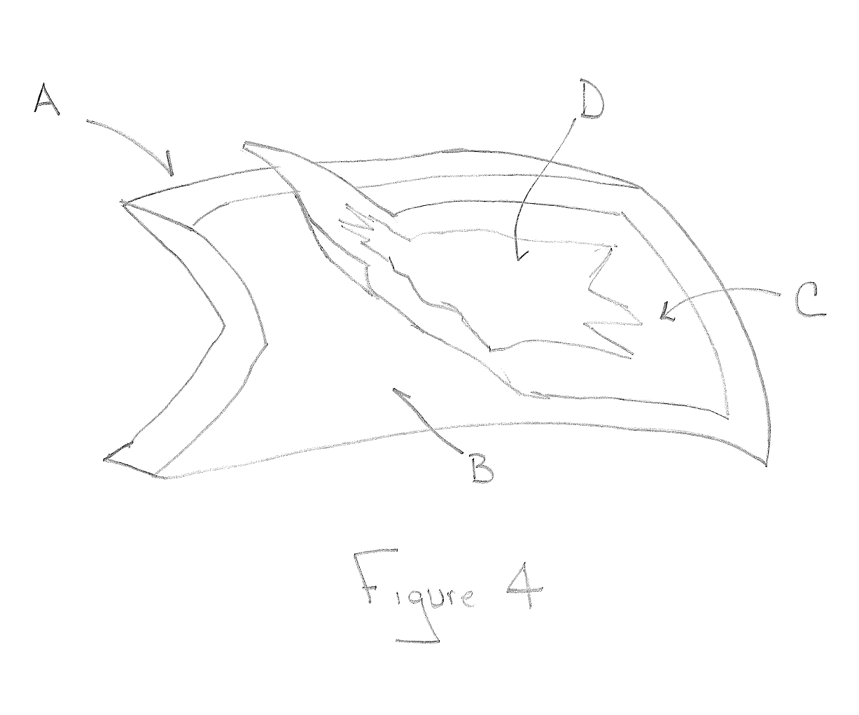

To better understand the advantages of the present inventive method, taking a look at prior techniques is instructive. Turning to FIG. 4, an example of a prior art, non-in molded plastic piece A is depicted. Plastic piece A further consists of plastic back and sticker C. Historically, sticker C has been applied to plastic back B after the molding process. This has occurred for many reasons, the principal among them being: (1) aligning the label in an appropriate location and having it hold position during the molding process of plastic pieces of complex configurations has been difficult and (2) creating a solid bond between the label and the plastic part (mainly on polypropylene) has also proven difficult.

To achieve adhesion of any kind of sticker C to plastic back B, markings D on sticker C must be applied to the outer surface E of sticker C. This results in the markings being readily susceptible to scratching which, in turn, results in the markings being prematurely destroyed. Application of sticker C after the molding of plastic back B also renders the markings susceptible to fading from UV exposure and in sticker C being exposed to peeling and chipping or ripping long before plastic back B is worn out or broken.

In molding techniques have overcome many of these shortcomings in uniformly shaped products. However, in molding has not been used successfully in complex geometry settings for the reason that until the present invention, there has not been a suitable and economical way to apply a label and hold in place for the molding process. Applicants' inventive process, overcomes these shortcomings in plastic pieces of complex geometry or that have holes in them on several levels. First, label 24 is accurately positioned on the mold and held in place and fused through the inventive method to plastic layer 22, thereby creating a bond between the two layers. Second, the inventive method enables indicia markings 36 to be placed on the interior surface 34 of label 24, thereby significantly reducing the opportunities for the markings to be scratched off, chipped, ripped, or peeled from the plastic layer. The inventive process also creates a product that is less susceptible to be damaged under TJV radiation, thus making the markings fade resistant.

Central to the inventive process is that the label 24 and plastic layer 22 are made of the same material. Owing to this fact, those skilled in the arts will quickly realize that any molding method will work and still be within the spirit and scope of the invention. The inventors have found, however, that injection molding works best. Due to the fact that the label and the plastic layer are made of the same material, the finished product is also environmental sound in that it can be recycled; unlike much of the prior art which typically are made of incompatible materials not suitable for recycling.

In injection molding the basic cycle is: 1) close Mold, 2) injection carriage forward, 3) inject plastic, 4) metering, 5) retract carriage, 6) open mold, and 7) eject part(s).

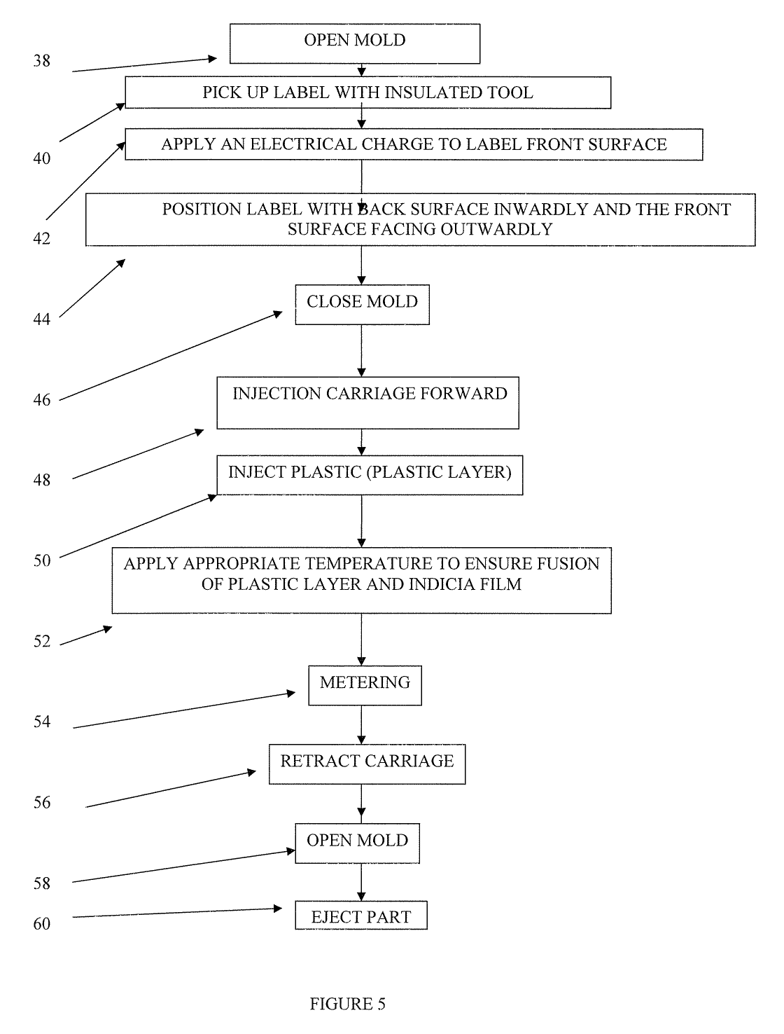

Turning to FIG. 5, it is seen that Applicants' inventive process generally expands the molding process to the following: 1) open mold 38, 2) pick up label with insulated robotic arm from three dimensional stack 40, 3) apply an electrical charge to front surface of label 42, 3) position label film with label front surface facing outwardly and the back surface facing inwardly 44, 4) close mold 46, 5) injection carriage forward 48, 6) inject plastic (plastic layer) 50, 7) apply appropriate temperature to ensure fusion of plastic layer and label film 52, 8) metering 54, 9) retract carriage 56, 10) open mold 58, and 11) eject part(s) 60.

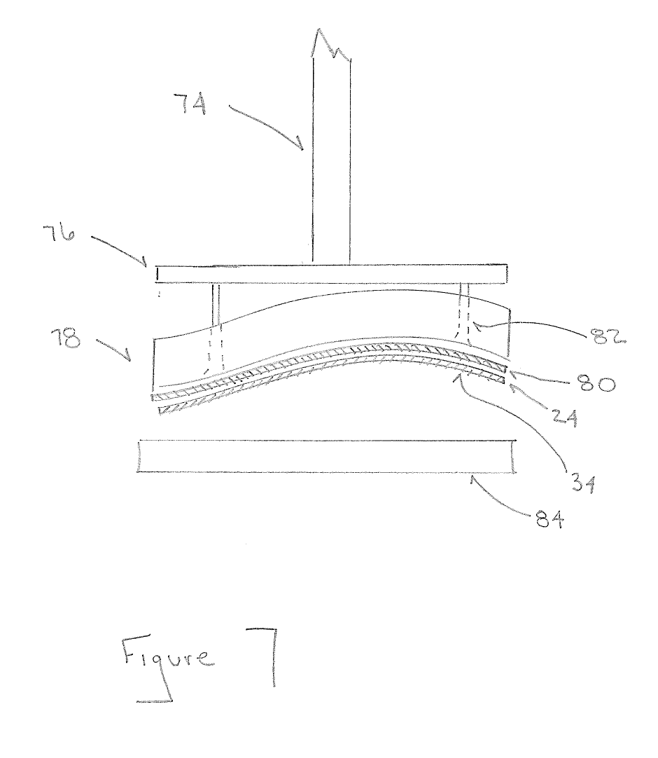

Placement of the label on a contoured surface has proved difficult in the past. The inventors have found that a combination of vacuum and the inventive electrical charging of their design eliminates this problem. In the inventive process, an improved apparatus (FIG. 7) in the form of a robotic arm 74 is fitted with an insulating plate 76 to eliminate electrical charge transfer to tool 74. An insulated shaper 78, for example an internal copy of the mold or a copy of key points of the mold, is affixed to robotic arm 74. The purpose of the shaper is to provide precise placement of label 24 onto the mold. Shaper 78 will be of the same shape as label 24 to be applied or will have the shape of critical points of label 24 to be applied. A semi-conductive foam 80 is applied to shaper 78. Foam 80 works to attract an electrical charge and direct it throughout label 24. Foam 80 also serves to protect the shaper from damage during the molding process. It is to be noted that while the inventors have found that a semi-conductive foam works well, the spirit and scope of the invention are not limited to this. For instance, a label that has insulating properties may be used so long as it will accept a charge on its front surface.

Vacuum I applied through suction ports 82 in the traditional manner to pick up a label from a storage area. Robotic arm 74 is passed by charging bar 84 such that label 24 is charged on its front surface 34. Shaper 78 with charged label is then placed in position over the mold and the label separates from shaper 78 and adheres, through the electrical charge on its front surface, to the mold. The vacuum is shut off. The molding process then proceeds normally.

Applying an electrical charge to the label helps to insure that there is correct positioning of the label on the mold. The charge may be applied using any conventional charge generating means. As discussed above, however, electrical charges have traditionally been applied to the back of a label. The inventors have discovered, that application of an electrical charge to the front of the label enables accurate label placment in contoured molds and/or those with holes in them. Due to the three dimensional features of shaper 78 and the electrical charge application to the front surface of the label, the label is positioned accurately for placement into the mold.

Those skilled in the arts will recognize that the above described process may be varied depending on equipment and molding needs. So long as the label film is properly positioned and the plastic layer is injected and the label film and the plastic layer are subjected to sufficient heat, the order and number of steps is not critical.

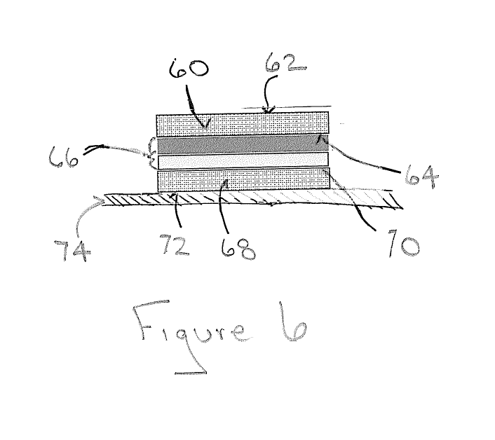

In a slight modification to the invention, a second label film layer may be used. Turning to FIG. 6, it can be seen that in this embodiment there is a first label film layer 60 having an exterior side 62 and an interior side 64, first label film interior side 64 has label markings 66 on it, second label film 68 having an second exterior side 70 and a second interior side 72 is placed under in first label film interior side 64, and plastic layer 74 is layered next on second label film second interior side 72.

As with the preferred embodiment, those skilled in the arts will recognize that the above described process may be varied depending on equipment and molding needs. So long as the label is properly positioned and plastic layer is injected and the films and plastic layer are subjected to sufficient heat, the order and number of steps is not critical.

It is acceptable to create a single unit comprising a first label film bonded to a seconded label film with label markings located to the interior of the first and second label films.

With regards to the characteristics of label 24, it is, as stated above, made of the same material as plastic layer 22 and preferably should be a plastic foil preferably of a thickness of about 300 μm, with a range of about 200 μm up to about 300 μm. The Inventors have discovered that thickness below 130 μm result in label bending, making it difficult to adjust properly to the shape of the part. Thicknesses above about 400 μm tend to initially bond well but are prone to cracking and separation with repeated flexion of plastic piece 20. The correct bond to the plastic layer is related to the label film characteristics. The thickness has a higher influence on the label performance to adjust to a 3D shape. If the label is not correctly shaped, fusion is affected. However, it is to be understood that the label thickness is not critical to the inventive process. As those skilled in the arts will quickly understand, label thickness will be dependent upon many factors including but not limited to temperature, metering time, molding process, and quality and skill of molding equipment and workman.

On interior surface 34 are formed label indicia or markings 36. Label markings 36 are the decorative features to be molded onto plastic layer 22. They may be of any color and variety and may further include illustrations, text, or other representational or non-representional decorative design. Label markings 36 may be done in any media, such as ink or paint, the only requirement being that the media is able to withstand the molding process without breaking down.

Experimentation by the Inventors has revealed that temperatures in the range of about 190° C. to about 240° C. works best in causing a good fusion of label film and plastic layer. However, it is to be understood that the temperature is not critical to the inventive process. As those skilled in the arts will quickly understand, temperature will be dependent upon many factors including but not limited to label thickness, metering time, molding process, thickness of the plastic layer, its size, shape and contours, and the size characteristics of the label and quality and skill of molding equipment and workman. The temperature must be high enough to cause the fusion but not so high as to destroy the properties of either the label or plastic layer.

One of the benfits of the inventive process is that, unlike the prior art, no cavity is required to be built into a mold to accommodate a label. Instead, the inventive process causes the label to be held in place through properly applied electrical charges. Accordingly, a mold with no label cavity can be used to form a finished product.

Injection molding has proven itself to be the preferred molding technique but other techniques can also be used. Injection molding is generally preferred over techniques, such as themroforming, because those techniques generally don't result in an label adhering as well to the plastic layer as with injection molding. However, this is generally as a result of the properties of the molding techniques and plastics used and not as a result of the inventive process or apparatus.

Further testing has demonstrated that polypropylene is superior over other plastics, such as PVC for the reason that, as with other molding techniques, other plastics do not have as good of a bond between the label and the plastic layer as is seen with polypropylene.

The result of the inventive process is a fusion between the label and the plastic layer, not a lamination as is seen in other molding processes.

Applying the inventive process results in a fully decorated plastic part 20 when it is ejected from the mold. The inventive process results in superior product produced in a time efficient and economical approach in that the label is added to the plastic layer in the molding process as opposed to a second procedure made necessary by prior art techniques.

It is to be understood, however, that even though numerous characteristics and advantages of the preferred and alternative embodiments have been set forth in the foregoing description, together with details of the structure and function of the embodiments, the disclosure is illustrative only, and changes may be made in detail, especially in matters of shape, size and arrangement of parts within the principles of the invention to the full extent indicated by the broad general meaning of the terms in which the appended claims are expressed.

We claim:

1) A method for molding label into plastic parts comprising the steps of:
providing a robotic arm having an insulated end with a shaper, the shaper being of a shape generally corresponding to the shape of a label, the label having a back surface and a front surface;
providing protective insulation for use between the shaper and label;
selecting a label to be molded into a plastic piece from a label stack, the label made of a selected plastic;
passing the label over an electrical charging bar to cause an electrical charge to be placed on the label front surface;
positioning the label into the mold; and,
injecting a plastic layer over the label film, the plastic layer being of the same selected plastic as the label film.

2) The manufacturing method of claim 1 including the further step of using an injection temperature in a range of about 190° C. to about 240° C.

3) The manufacturing method of claim 1 including the further step of using a label of between 200 μm and 300 μm in thickness.

4) The label film of claim 3 wherein the label thickness is 300 μm.

5) The manufacturing method of claim 1 the insulation is a semi-conductive foam.

6) The manufacturing method of claim 1 wherein the selected plastic of the label and the plastic layer are polypropylene.

7) The manufacturing method of claim 1 wherein the label is transparent.

8) The manufacturing method of claim 1 wherein placing the plastic layer over the label member is accomplished through injection molding.

9) An apparatus for molding labels having a back surface and a front surface to plastic in an in molding process for parts of irregular shape, the improvement comprising a robotic arm having an insulated end, a shaper generally corresponding in shape to the shape of a label having a front surface and a back surface, adjacent the insulated end, and a charging bar for applying an electrical charge to the label front surface.

10) The apparatus of claim 9 wherein an insulation is placed between the shaper and the label.

11) The insulation of claim 10 wherein the insulation is a semi-conductive foam.

12) The apparatus of claim 9 wherein the label thickness is between 200 μm and 300 μm.

13) The label film of claim 12 wherein the label thickness is 300 μm.
